(19) United States
(12) Patent Application Publication
(10) Pub. No.: US 2025/0387848 A1
(43) Pub. Date: Dec. 25, 2025

(54) PLASMA GAS FLOW CONTROL FOR TORCH SYSTEM

(71) Applicant: The ESAB Group, Inc., North Bethesda, MD (US)

(72) Inventor: Erik Anthony Leger, Newmarket, NH (US)

(21) Appl. No.: 19/247,356

(22) Filed: Jun. 24, 2025

Related U.S. Application Data
(60) Provisional application No. 63/663,288, filed on Jun. 24, 2024.

(51) Int. Cl. B23K 10/00

(52) U.S. Cl. CPC B23K 10/006

(57) ABSTRACT

A plasma torch system includes a regulator configured to direct a first portion of the gas flow from a gas source toward a consumable of a plasma torch, the regulator being configured to regulate a pressure of the first portion of the gas flow directed toward the consumable based on a pressure in a pilot chamber. The plasma torch system also includes a valve fluidly coupled to the pilot chamber and configured to direct a second portion of the gas flow from the gas source toward the pilot chamber. The valve, in the first position, is configured to increase the pressure in the pilot chamber at a first ramp rate, and the valve, in the second position, is configured to decrease the pressure in the pilot chamber at a second ramp rate.

### CROSS-REFERENCE TO RELATED APPLICATION

This application claims priority to and the benefit of U.S. Provisional Patent Application No. 63/663,288, entitled “PLASMA GAS FLOW CONTROL FOR TORCH SYSTEM,” filed Jun. 24, 2024, which is hereby incorporated by reference in its entirety for all purposes.

### TECHNICAL FIELD

The present disclosure is directed toward welding and/or cutting torches and, in particular, to systems and methods of controlling plasma gas flow.

### BACKGROUND

A torch, such as a cutting torch or a welding torch, is used to perform various operations with respect to a metal workpiece. For example, the torch may be used to remove material from the metal workpiece for a cutting operation or to melt material for a welding operation. In either case, the torch includes a torch body and at least one consumable component (e.g., in addition to consumable wire). Plasma gas is directed through the torch to facilitate generating an arc to perform the operation with respect to the metal workpiece. In some implementations, it may be desirable to adjust the pressure in which plasma gas is directed to/through the torch.

### SUMMARY

The present disclosure is directed towards controlling gas flow to/through a torch system, such as toward a consumable. These techniques may be embodied as at least a plasma torch system and a method.

In accordance with at least one embodiment, the present application is directed to a plasma torch system configured to direct a gas flow from a gas source toward a consumable of a plasma torch. The plasma torch system includes a regulator configured to receive a first portion of the gas flow from the gas source and direct the first portion of the gas flow toward the consumable of the plasma torch, the regulator including a pilot chamber and being configured to regulate a pressure of the first portion of the gas flow directed toward the consumable of the plasma torch based on a pressure in the pilot chamber. The plasma torch system also includes a valve fluidly coupled to the pilot chamber of the regulator and configured to direct a second portion of the gas flow from the gas source toward the pilot chamber. The valve is configured to transition between a first position and a second position, such that the valve, in the first position, is configured to increase the pressure in the pilot chamber at a first ramp rate, and the valve, in the second position, is configured to decrease the pressure in the pilot chamber at a second ramp rate.

In accordance with at least another embodiment, the present application is directed to a method for directing a gas flow from a gas source toward a consumable of a plasma torch. The method includes directing a first portion of the gas flow from the gas source to a regulator that includes a pilot chamber, regulating, via the regulator, a pressure of the first portion of the gas flow directed toward the consumable based on a pressure in the pilot chamber of the regulator, directing a second portion of the gas flow from the gas source to a valve fluidly coupled to the pilot chamber of the regulator, and adjusting the pressure in the pilot chamber of the regulator via the valve. The valve is configured to transition between a first position and a second position, the valve is configured to increase the pressure in the pilot chamber in the first position, and the valve is configured to decrease the pressure in the pilot chamber in the second position.

In accordance with at least a further embodiment, the present application is directed to a plasma torch system configured to direct gas flow from a gas source toward a plasma torch. The plasma torch system includes a regulator configured to receive a first portion of gas flow from the gas source and direct the first portion of gas flow toward the consumable of the plasma torch, the regulator including a pilot chamber and being configured to regulate a pressure of the first portion of gas flow directed toward the consumable of the plasma torch based on a pressure in the pilot chamber. The plasma torch system also includes a valve assembly comprising a valve and a line configured to direct a second portion of gas flow from the gas source toward the pilot chamber of the regulator via the valve to control the pressure of the first portion of the gas flow with the second portion of the gas flow.

Other systems, methods, features and advantages will be, or will become, apparent to one with skill in the art upon examination of the following figures and detailed description. All such additional systems, methods, features and advantages are included within this description, are within the scope of the claimed subject matter.

### BRIEF DESCRIPTION OF THE DRAWINGS

The techniques presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch, according to an example embodiment of the present disclosure.

FIG. 2 illustrates a schematic diagram of a torch system configured to direct gas from a gas source toward a consumable, according to an example embodiment of the present disclosure.

FIG. 3 illustrates a schematic diagram of another torch system configured to direct gas from a gas source toward a consumable, according to an example embodiment of the present disclosure.

FIG. 4 illustrates a schematic diagram of yet another torch system configured to direct gas from a gas source toward a consumable, according to an example embodiment of the present disclosure.

FIG. 5 illustrates a flowchart of a method for operating a torch system to control gas flow from a gas source toward a consumable, according to an example embodiment of the present disclosure.

FIG. 6 illustrates a flowchart of another method for operating a torch system to control gas flow from a gas source toward a consumable, according to an example embodiment of the present disclosure.

FIG. 7 illustrates a hardware block diagram of a computing device that may execute the techniques presented herein.

### DETAILED DESCRIPTION

The following description is not to be taken in a limiting sense but is given solely for the purpose of describing the broad principles of the present application. Embodiments of the present application will be described by way of example, with reference to the above-mentioned drawings showing elements and results of such embodiments.

The present disclosure is directed to controlling gas flow (e.g., air, nitrogen, argon, other inert gas) from a gas source toward a consumable of a torch. The consumable uses the gas flow to generate, sustain, and/or shield an arc for performing a cutting and/or welding operation. It is desirable to pressurize the gas flow to a target pressure that facilitates generating the arc. To this end, a regulator is used to control the pressure of gas flow discharged toward the consumable, such as by pressurizing the gas flow toward the target pressure and/or maintaining the pressure of the gas flow at around the target pressure.

The regulator includes a pilot chamber, and the regulator effectuates a threshold pressure for gas flow discharged toward the consumable based on a pressure within the pilot chamber. By way of example, increasing the pressure within the pilot chamber may increase the threshold pressure, whereas decreasing the pressure within the pilot chamber may reduce the threshold pressure. A pilot circuit is used to adjust the pressure within the pilot chamber by controlling an amount of gas within the pilot chamber. For example, the pilot circuit may include a valve that controls a portion of gas flow directed from the gas source into the pilot chamber. The valve may be adjusted to increase or decrease gas flow into the pilot chamber, thereby adjusting gas and pressure buildup in the pilot chamber. In certain embodiments, the valve may also be adjusted to direct gas flow out of the pilot chamber, thereby reducing the amount of gas and pressure in the pilot chamber. In additional or alternative embodiments, a separate valve is configured to direct gas flow out of the pilot chamber, and the amount of gas within the pilot chamber changes based on the flowrate of gas flow directed into the pilot chamber relative to the flowrate of gas flow directed out of the pilot chamber.

By apportioning the gas flow for generating the arc and for controlling operation of the regulator, operations for controlling gas flow (e.g., pressurization of the gas flow) toward the consumable may be simplified. For instance, implementation and operation of a dedicated gas source or other device/system used for controlling the regulator (e.g., by adjusting the pressure in the pilot chamber) may be avoided. Additionally, operations to control gas flow into and/or out of the pilot chamber may be performed without usage of a sensor. By way of example, the valve(s) may be suitably adjusted (e.g., between positions) to adjust gas flow directed into and/or out of the pilot chamber at substantially constant rates, thereby adjusting the pressure in the pilot chamber and, correspondingly, the threshold pressure of gas flow directed from the regulator toward the consumable at correspondingly constant rates. Therefore, a more complicated control scheme, such as one utilizing sensor feedback to repetitively and/or iteratively adjust the amount of gas and pressure in the pilot chamber, may be avoided. Thus, the operations discussed herein may be more readily implemented to control the pressure of gas flow directed toward the consumable. Simplifying the gas system is particularly important for welding and cutting operations, because gas components are becoming increasingly expensive. Moreover, complicated gas systems may be more prone to breakdowns and can require complicated protective measures (e.g. EMI shielding), because welding and cutting create harsh environments with magnetic fields that can render electrically controlled components inoperable.

Although the present disclosure primarily discusses controlling pressure of gas flow used to generate an arc, the described techniques may be used to control pressure of any other suitable gas flow. By way of example, the pressure of gas flow used to shield and maintain a generated arc may be controlled using any of the features discussed herein.

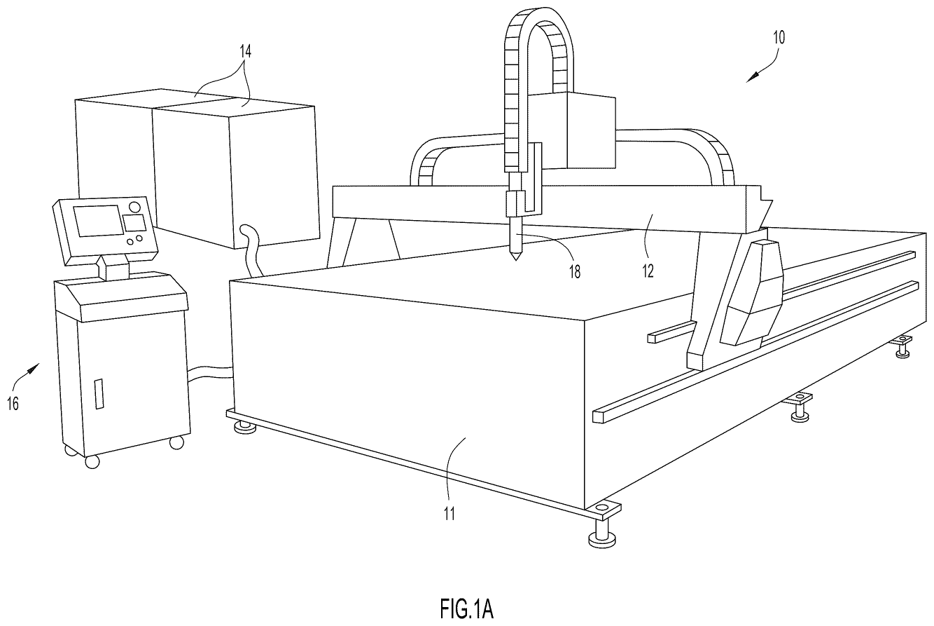

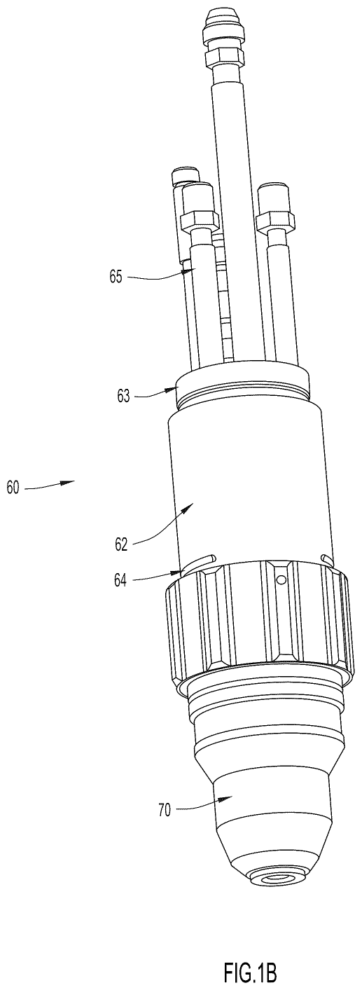

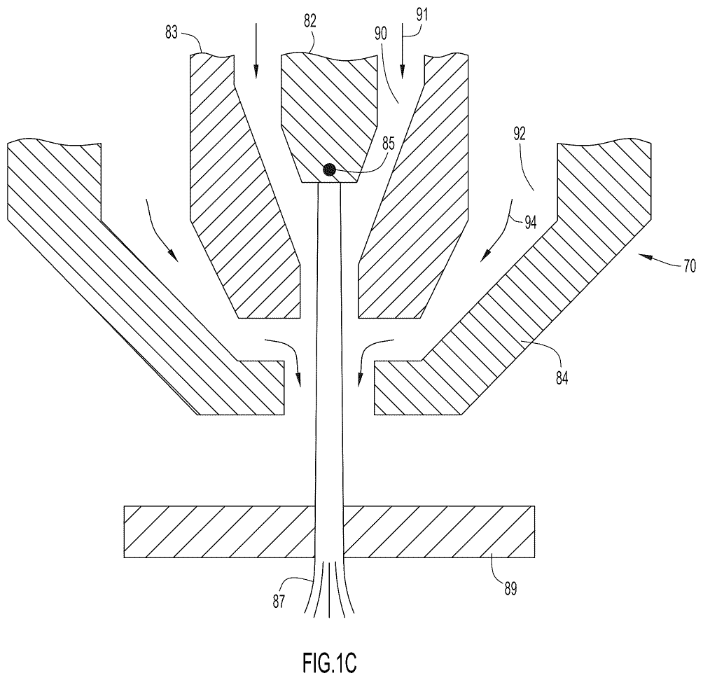

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system 10 also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated cutting system 10 may include a separate fluid supply unit (not shown) or units that can provide one or more fluids to the automated torch 18 independent of the one or more power supplies 14. To be clear, as used herein, the term “fluid” shall be construed to include a gas or a liquid. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated cutting system 10 may be any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 (a consumable stack/assembly) to connect to the torch body 62 in detail. However, it should be understood that the cutting consumables, such as those schematically illustrated in FIG. 1C, may be coupled to a torch body 62 in any manner. Moreover, to be clear, the consumable stack/assembly 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrate an interior of torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle 83, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated.

Regardless of the consumable properties, it may be desirable to control the pressure in which the plasma gas 91 and/or the shield fluid 94 is directed through the consumable stack 70 to generate the plasma arc 87. For example, directing the plasma gas 91 and/or the shield fluid 94 at a particular pressure may facilitate generating the plasma arc 87. For this reason, gas flow (e.g., directed toward the consumable stack 70) may be controlled to enable a torch to operate more desirably.

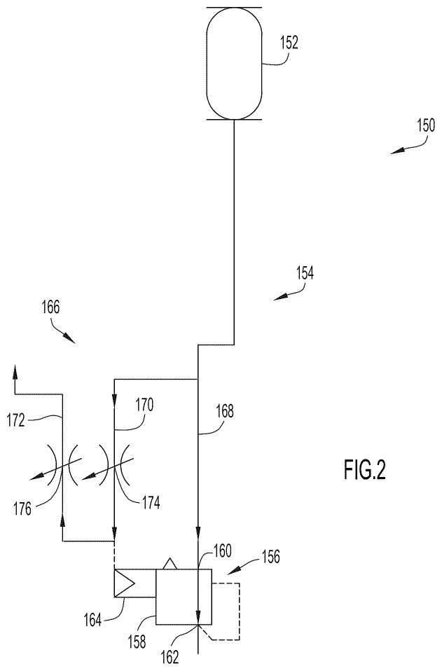

FIG. 2 is a schematic diagram of a torch system 150 configured to direct a gas flow (e.g., the plasma gas 91) from a gas source 152 toward a consumable (e.g., the consumable stack 70) of a torch for generating an arc. The torch system 150 includes a conduit assembly 154 configured to receive gas from the gas source 152. The conduit assembly 154 includes a regulator 156 (e.g., a dome-loaded regulator) configured to regulate a pressure of gas flow directed toward the consumable. The regulator 156 includes a main body 158 configured to receive gas flow from the gas source 152 via an inlet 160, pressurize the received gas flow to a threshold pressure for generating an arc, and discharge the pressurized gas flow toward the consumable via an outlet 162 to generate the arc. The regulator 156 also includes a pilot chamber 164. A pressure within the pilot chamber 164 controls the threshold pressure to which the regulator 156 pressurizes gas flow within the main body 158 for discharge toward the consumable. For example, increasing the pressure within the pilot chamber 164 increases the threshold pressure, whereas decreasing the pressure within the pilot chamber 164 reduces the threshold pressure. The reverse might also be true in some embodiments (i.e., pressure in the pilot chamber 164 and threshold pressure have an inverse relationship).

Regardless of the control scheme, the pressure within the pilot chamber 164 can be adjusted to correspondingly adjust the pressure of gas flow directed toward the consumable. In some embodiments, a portion of the conduit assembly 154 is positioned within a torch (e.g., a torch body coupled to the consumable) and is configured to control gas flow through the torch. In additional or alternative embodiments, the conduit assembly 154 is positioned exterior to the torch and is configured to control gas flow between the gas source 152 and the torch.

The pressure within the pilot chamber 164 is adjusted by changing an amount of gas within the pilot chamber 164. For example, a portion of the gas flow from the gas source 152 may be directed toward the pilot chamber 164 of the regulator 156 via a pilot circuit 166 of the conduit assembly 154. That is, gas flow from the gas source 152 is apportioned between the pilot chamber 164 and the main body 158. In turn, a first portion (e.g., a relatively larger portion) of gas flow is directed through the main body 158 via a main line 168 of the conduit assembly 154, and a second portion (e.g., a relatively smaller portion) of gas flow is directed to the pilot chamber 164 via a first line 170 of the pilot circuit 166. Thus, changing the flowrate of gas directed through the first line 170 into the pilot chamber 164 adjusts the amount of gas within the pilot chamber 164 and the threshold pressure that gas is discharged from the regulator 156 toward the consumable. By using the same gas flow for generating the arc via the consumable and for controlling the threshold pressure effectuated by the regulator 156, operation of the torch system 150 may be simplified. For instance, implementation and operation of a separate gas source dedicated to providing gas flow to the pilot chamber 164 of the regulator 156 is avoided. Additionally or alternatively, the torch system 150 need not include control signals or associated electronics that may be at risk of malfunctioning in a cutting or welding environment. Instead of these active signal/electronic controls, the techniques presented herein utilize “passive control” of a gas that is effectuated by the gas being metered/controlled within the pilot chamber 164 of the regulator 156.

A second line 172 of the pilot circuit 166 directs gas flow out of the pilot chamber 164. For example, the second line 172 may direct gas flow to an external environment to avoid pressure buildup within the pilot chamber 164. In certain embodiments, gas flow is directed through the second line 172 at a first flowrate. Thus, directing gas flow through the first line 170 into the pilot chamber 164 at a flowrate different from the first flowrate adjusts the pressure within the pilot chamber 164. By way of example, directing gas flow through the first line 170 at a second flowrate greater than the first flowrate increases the amount of gas, and therefore the pressure, within the pilot chamber 164. Meanwhile, directing gas flow through the first line 170 at a third flowrate less than the first flowrate reduces the amount of gas, and therefore the pressure, within the pilot chamber 164.

A first variable orifice control 174 is implemented to adjust the flowrate of gas directed through the first line 170 by adjusting a size of the opening of the first line 170. The first variable orifice control 174 may include a first valve (e.g., a first manually set needle valve, a first check valve, a first cylinder speed controller) that can transition between a first position and a second position. In the first position, the first valve enables gas flow through the first line 170 at the second flowrate greater than the first flowrate. In the second position, the first valve enables gas flow through the first line 170 at the third flowrate less than the first flowrate (e.g., the third flowrate may be a zero flowrate). Thus, the first valve may be set at the first position to increase pressure within the pilot chamber 164 and at the second position to reduce pressure within the pilot chamber 164.

In some implementations, it may be desirable to ramp the threshold pressure of gas flow effectuated by the regulator at a constant rate. For instance, ramping the threshold pressure of gas to change more smoothly reduces effects of lead length, frictional losses, sudden pressure changes, and other factors that may affect the structural integrity of the consumable. As an example, to increase the threshold pressure of gas flow at a first constant rate (e.g., upon initiation of the operation of the torch system) for a first duration of time, the first variable orifice control 174 is transitioned to the first position to direct gas flow into the pilot chamber 164 at the second flowrate. Consequently, gas builds within the pilot chamber 164 at a constant rate that is approximately a difference between the second flowrate of gas flow directed into the pilot chamber 164 and the first flowrate of gas flow directed out of the pilot chamber 164. The pressure within the pilot chamber 164 may then increase at a proportionally constant ramp rate (e.g., a first ramp rate).

As another example, to reduce the threshold pressure of gas flow at a second constant rate (e.g., to shut down or suspend operation of the torch system 150) for a second duration of time, the first variable orifice control 174 is transitioned to the second position to direct gas flow into the pilot chamber at the third flowrate. As a result, gas is discharged from the pilot chamber 164 at a constant rate that is approximately a difference between the first flowrate of gas flow directed out of the pilot chamber 164 and the third flowrate of gas flow directed into the pilot chamber 164. The pressure within the pilot chamber 164 may then decrease at a proportionally constant ramp rate (e.g., a second ramp rate). In other words, gas flow is directed out of the pilot chamber 164 via the second line 172 at a constant flowrate and gas flow is directed into the pilot chamber via the first line 170 at a variable flowrate to change the amount of gas within the pilot chamber 164.

In additional or alternative embodiments, a second variable orifice control 176 is implemented to adjust the flowrate of gas directed through the second line 172 by adjusting a size of the opening of the second line 172. The second variable orifice control 176 may include a second valve (e.g., a second manually set needle valve, a second check valve, a second cylinder speed controller) that can transition between a third position and a fourth position. In the third position, the second valve enables gas flow through the second line 172 at the first flowrate that is less than the second flowrate. In the fourth position, the second valve enables gas flow through the second line 172 at a fourth flowrate that is greater than the first flowrate (e.g., greater than the third flowrate). Thus, the second valve may be set at the third position to increase pressure within the pilot chamber 164 and at the fourth position to reduce pressure within the pilot chamber 164.

By way of example, while gas flow is directed into the pilot chamber 164 via the first line 170 at the second flowrate, the second valve may be transitioned to the third position to direct gas flow out of the pilot chamber 164 via the second line 172 at the first flowrate. As a result, the amount of gas in the pilot chamber 164 increases at a constant rate that is approximately a difference between the second flowrate of gas flow directed into the pilot chamber 164 and the first flowrate of gas flow directed out of the pilot chamber. Additionally, while gas flow is directed into the pilot chamber 164 via the first line 170 at the first flowrate, the second valve may be transitioned to the fourth position to direct gas flow out of the pilot chamber 164 via the second line 172 at the fourth flowrate. Consequently, the amount of gas in the pilot chamber 164 decreases at a constant rate that is approximately a difference between the fourth flowrate of gas flow directed out of the pilot chamber 164 and the second flowrate of gas flow directed into the pilot chamber 164. In other words, gas flow may be directed into the pilot chamber 164 via the first line 170 at a constant flowrate and gas flow may be directed out of the pilot chamber 164 via the second line 172 at a variable flowrate to adjust the amount of gas within the pilot chamber 164.

In further embodiments, the position each of the first valve and the second valve is adjusted to change the pressure within the pilot chamber 164. By way of example, to increase pressure within the pilot chamber 164, the first valve may be transitioned to the first position and the second valve may be transitioned to the third position such that gas is directed into the pilot chamber 164 at a constant rate that is approximately a difference between the first flowrate of gas flow directed into the pilot chamber 164 and the second flowrate of gas directed out of the pilot chamber 164. To reduce pressure within the pilot chamber 164, the first valve may be transitioned to the second position and the second valve may be transitioned to the fourth position such that gas is directed out of the pilot chamber 164 at a constant rate that is approximately a difference between the fourth flowrate of gas flow directed out of the pilot chamber 164 and the third flowrate of gas flow directed into the pilot chamber 164. As such, gas flow is directed into the pilot chamber 164 via the first line 170 and out of the pilot chamber 164 via the second line 172 at variable flowrates to adjust the amount of gas within the pilot chamber 164. In any case, a difference between the flowrate of gas directed into the pilot chamber 164 and the flowrate of gas directed out of the pilot chamber 164 is maintained to adjust the pressure in the pilot chamber 164 at a constant ramp rate.

Further still, at least one of the valves may be closed to adjust the amount of gas and pressure within the pilot chamber 164. For instance, to increase the pressure within the pilot chamber 164, the first valve may be open (e.g., transitioned to the first position), while the second valve may be closed. Consequently, gas flow is directed into the pilot chamber 164 via the first line 170 while gas flow is not directed out of the pilot chamber 164 via the second line 172, thereby increasing the pressure within the pilot chamber 164. To reduce the pressure within the pilot chamber 164, the first valve may be closed, while the second valve may be open (e.g., transitioned to the fourth position). As a result, gas flow is directed out of the pilot chamber 164 via the second line 172 while gas flow is not directed into the pilot chamber 164 via the first line 170, thereby decreasing the pressure within the pilot chamber 164.

Although each of the first valve and the second valve is described as transitioning between two positions, it should be noted that the first valve and/or the second valve may be configured to transition between any suitable quantity of positions, such as intermediate positions, in additional or alternative embodiments. Indeed, the first valve and/or the second valve may be transitioned to any combination of positions to adjust the amount of gas within the pilot chamber 164 more granularly, such as at multiple different ramp rates. However, two-position valves may also be advantageous, because such valves are simple to operate and, with the techniques presented herein, can sufficiently effectuate pressure ramping without constant monitoring and feedback. Two-position valves may also provide cost savings as compared to proportional valves or other multi-position valves.

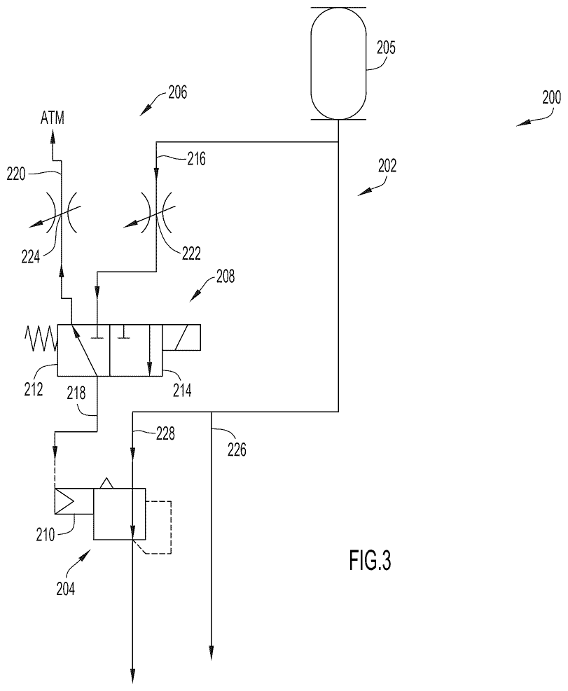

FIG. 3 is a schematic diagram of another torch system 200 that includes a conduit assembly 202 with a regulator 204 configured to regulate a pressure of gas flow directed from a gas source 205 toward the consumable for generating an arc. The conduit assembly 202 also includes a pilot circuit 206 with a two position valve 208 (e.g., a three port two position valve) configured to control gas flow into and/or out of a pilot chamber 210 of the regulator 204 to adjust the pressure within the pilot chamber 210. The two position valve 208 is configured to transition between a first position 212 and a second position 214. For example, the two position valve 208 may be a solenoid valve configured to transition to one of the positions 212, 214 upon receipt of a control signal and to transition to the other of the positions in absence of the control signal.

The pilot circuit 206 includes a first line 216 configured to direct gas flow from the gas source 205 to the two position valve 208, a second line 218 configured to direct gas flow between the pilot chamber 210 and the two position valve, and a third line 220 configured to direct gas flow to an external environment. In the illustrated embodiment, the two position valve 208 is in the first position 212, which fluidly couples the second line 218 and the third line 220 with one another. Thus, the first position 212 of the two position valve 208 enables gas flow away from the pilot chamber 210 to the external environment via the second line 218 and the third line 220. Additionally, the first position 212 of the two position valve 208 fluidly separates the first line 216 and the second line 218 from one another to block gas flow from the gas source 205 into the pilot chamber 210 via the first line 216. As such, the first position 212 of the two position valve 208 reduces the amount of gas within the pilot chamber 210 to reduce the pressure in the pilot chamber 210 (e.g., to reduce the threshold pressure effectuated by the regulator 204).

The second position 214 of the two position valve 208 fluidly couples the first line 216 and the second line 218 with one another, thereby enabling gas flow from the gas source 205 into the pilot chamber 210 via the first line 216 and the second line 218. In addition, the second position 214 of the two position valve 208 fluidly separates the second line 218 and the third line 220 from one another to block gas flow out of the pilot chamber 210 via the third line 220. Thus, the second position 214 of the two position valve 208 increases the amount of gas within the pilot chamber 210 to increase the pressure in the pilot chamber 210 (e.g., to increase the threshold pressure effectuated by the regulator 204).

In some embodiments, the two position valve 208 is configured to direct gas flow into and/or out of the pilot chamber 210 at constant flowrates. For instance, the first position 212 of the two position valve 208 may direct gas flow through the two position valve 208 at a first flowrate to reduce the amount of gas within the pilot chamber 210 at the first flowrate via the second line 218 and the third line 220. Consequently, the pressure within the pilot chamber 210 is reduced at a first ramp rate to reduce the threshold pressure effectuated by the regulator 204. The second position of the two position valve 208 may direct gas flow through the two position valve 208 at a second flowrate to increase the amount of gas within the pilot chamber 210 at the second flowrate via the first line 216 and the second line 218. As such, the pressure within the pilot chamber 210 increases at a second ramp rate to increase threshold pressure effectuated by the regulator 204. For this reason, the two position valve 208 is maintained at the first position 212 to increase the threshold pressure effectuated by the regulator 204 (e.g., to ramp up gas pressure), and the two position valve 208 is maintained at the second position 214 to reduce the targe pressure effectuated by the regulator 204 (e.g., to ramp down gas pressure).

In some embodiments, variable orifice controls are implemented to adjust the flowrate of gas flow directed into and/or out of the pilot chamber 210. For example, a first variable orifice control 222 may be implemented at the first line 216 to adjust gas flow directed through the first line 216 (e.g., into the pilot chamber 210 while the two position valve 208 is in the second position 214). Additionally or alternatively, a second variable orifice control 224 may be implemented at the third line 220 to adjust gas flow directed through the third line 220 (e.g., out of the pilot chamber 210 while the two position valve 208 is in the first position 212). Thus, even though the two position valve 208 directs gas flow at constant flowrates therethrough, the variable orifice controls 222, 224 may be operated to adjust the flowrate of gas flow directed into and/or out of the pilot chamber 210.

The illustrated torch system 200 also includes a fourth line 226 configured to direct a portion of the gas flow (e.g., the shield fluid 94) for shielding a generated arc and/or cooling certain components (e.g., the nozzle) of the torch. As such, a first portion of gas flow from the gas source 205 is directed toward the two position valve 208 via the first line 216, a second portion of gas flow from the gas source 205 is directed toward the consumable via a main line 228 and the regulator 204 for generating an arc, and a third portion of gas flow is directed from the gas source 205 toward the consumable via the fourth line 226 for shielding the arc. In other words, gas flow from the gas source 205 is apportioned between controlling the threshold pressure effectuated by the regulator 204, generating the arc via the consumable, and shielding the arc generated by the consumable. For example, in certain operations (e.g., pre-flow operations, post-cut operations), the valve 258 may be transitioned to the first position 212 to remove substantially all gas within the pilot chamber 210, which may suspend operation of the regulator 204. That is, no gas flows from the gas source 205 to the pilot chamber 210 or out of the regulator 204. Consequently, substantially all gas from the gas source 205 is directed through the fourth line 226 to provide full shielding and/or cooling functionalities. Additional or alternative line configurations, such as a dedicated cooling line (e.g., that does not shield an arc) providing other functionalities may also be implemented in other embodiments presented herein if desired.

The torch system 150, 200 illustrated in each of FIGS. 2 and 3 may adjust the pressure within a pilot chamber using a relatively less complex operational scheme. For instance, a valve may be adjusted between a plurality of positions to control the amount of gas within a pilot chamber. Each of the plurality of positions of the valve enables gas flow through the valve into and/or out of the pilot chamber at a respective constant rate. Thus, the valve may be controlled to change the pressure in the pilot chamber at a constant, predictable rate without having to use a sensor that monitors the exact pressure within the pilot chamber and to adjust (e.g., constantly adjust) the pressure based on feedback from the sensor. Instead, for example, the valve may be set at one position for a duration of time to increase the pressure in the pilot chamber at a first ramp rate toward a target pressure and then switched to a different position for another duration of time to reduce the pressure in the pilot chamber at a second ramp rate toward another target pressure. As such, the torch system may be more readily implemented and/or operated to control gas flow, such as without having to install additional control components and/or consume an excessive amount of energy for operating such control components to perform a complicated feedback control loop.

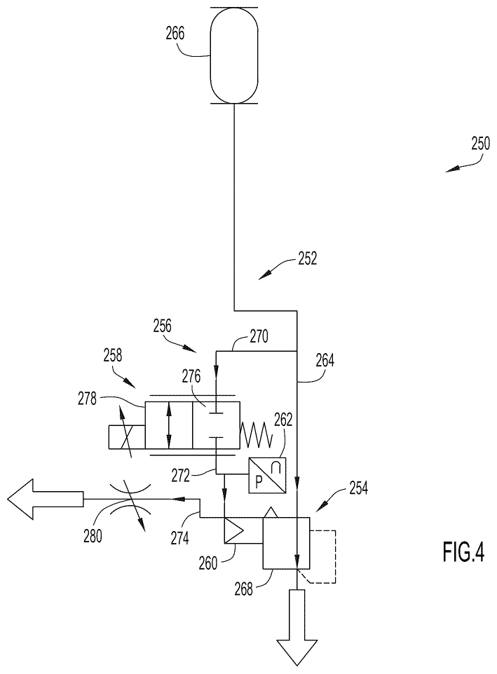

However, gas flow into and/or out of the pilot chamber may be controlled based on sensor feedback in some embodiments. FIG. 4 is a schematic diagram of a torch system 250 that includes a conduit assembly 252 with a regulator 254 configured to regulate a pressure of gas flow directed toward the consumable for generating an arc. The conduit assembly 252 additionally includes a pilot circuit 256 with a valve 258 configured to control gas flow into and/or out of a pilot chamber 260 of the regulator 254 to adjust the pressure within the pilot chamber 260. The pilot circuit 256 includes a sensor 262 configured to determine a pressure within the pilot chamber 260 for controlling the gas flow into and/or out of the pilot chamber 260 via the valve 258.

A main line 264 of the conduit assembly 252 is configured to direct gas flow from a gas source 266 to a main body 268 of the regulator 254. A first line 270 of the pilot circuit 256 is configured to direct gas flow from the gas source 266 toward the valve 258. A second line 272 of the pilot circuit 256 is configured to direct gas flow from the valve 258 to the pilot chamber 260. A third line 274 of the pilot circuit 256 is configured to direct gas flow from the pilot chamber 260 to an external environment.

The valve 258 is configured to transition between a first position 276 and a second position 278. In the illustrated embodiment, the valve 258 is in the first position 276 that fluidly separates the first line 270 and the second line 272 from one another to block gas flow from the gas source 266 to the pilot chamber 260. However, the third line 274 of the pilot circuit 256 is configured to direct gas flow out of the pilot chamber 260 while the valve 258 is in the first position 276. Thus, the amount of gas within the pilot chamber 260 is reduced via the third line 274 to reduce the pressure in the pilot chamber 260. In the second position 278, the valve 258 fluidly couples the first line 270 and the second line 272 with one another to enable gas flow from the gas source 266 to the pilot chamber 260. The third line 274 of the pilot circuit 256 is also configured to direct gas flow out of the pilot chamber 260 while the valve 258 is in the second position 278. As such, to increase gas and pressure in the pilot chamber 260, the second position 278 of the valve 258 directs gas flow into the pilot chamber 260 at a first flowrate that is greater than a second flowrate in which gas flow is directed from the pilot chamber 260 through the third line 274. In some embodiments, the valve 258 is also configured to be moved to an intermediate position between the first position 276 and the second position 278. For example, the valve 258 may be a proportional valve that can direct gas flow into the pilot chamber 260 at a flowrate different from the first flowrate to change the rate in which the amount of gas in the pilot chamber 260 is adjusted. In some embodiments, the valve 258 is a solenoid valve configured to transition between different positions based on a received control signal.

The sensor 262 is used to monitor a parameter indicative of a pressure within the pilot chamber 260. The pressure within the pilot chamber 260 indicates the threshold pressure of gas flow discharged from the regulator 254 toward a consumable (e.g., for generating an arc). For example, it may be desirable for the regulator 254 to output gas flow at a target threshold pressure. To enable the regulator 254 to output gas flow at the target threshold pressure, the pressure within the pilot chamber 260 is to be adjusted to a target pressure. The sensor 262 is used to determine whether the pressure within the pilot chamber 260 is at the target pressure to cause the regulator 254 to output gas flow at the target threshold pressure. The valve 258 is then operated based on the determined pressure within the pilot chamber 260.

As an example, in response to determining that the pressure within the pilot chamber 260 substantially matches the target pressure (e.g., a difference between the determined pressure and the target pressure is below a threshold value), the valve 258 may be controlled to maintain the determined pressure within the pilot chamber 260. However, in response to determining that the pressure within the pilot chamber 260 does not substantially match the target pressure (e.g., a difference between the determined pressure and the target pressure is above the threshold value), the valve 258 may be controlled to adjust the determined pressure toward the target pressure. For instance, the valve 258 may be moved toward the second position 278 to increase the pressure within the pilot chamber 260 in response to determining that the pressure within the pilot chamber 260 is below the target pressure, and the valve 258 may be moved toward the first position 276 to reduce the pressure within the pilot chamber 260 in response to determining that the pressure within the pilot chamber 260 is above the target pressure. Thus, sensor feedback is used to control movement of the valve 258 (e.g., via a proportional-integral-derivative (PID) control loop and circuitry) to adjust the pressure in the pilot chamber 260. In certain embodiments, the rate (e.g., ramp rate) in which the pressure within the pilot chamber 260 is adjusted via the valve 258 is based on the difference between the determined pressure in the pilot chamber 260 and the target pressure. For example, the valve 258 is controlled to increase the rate in which the pressure within the pilot chamber 260 is adjusted toward the target pressure based on there being a greater difference between the determined pressure in the pilot chamber 260 and the target pressure.

While the valve 258 is primarily controlled to adjust the pressure in the pilot chamber 260, in some embodiments, a variable orifice control 280 (e.g., a valve) is implemented at the third line 274 to adjust the flowrate in which gas is directed out of the pilot chamber 260. For example, the variable orifice control 280 may be adjusted in addition to or as an alternative to adjustment of the valve 258 to change the rate in which the amount of gas within the pilot chamber 260 is adjusted. Indeed, the variable orifice control 280 may increase the flowrate of gas flow out of the pilot chamber 260 to reduce the pressure in the pilot chamber 260 and/or reduce the flowrate of gas flow out of the pilot chamber 260 to increase the pressure in the pilot chamber 260.

In any of these torch system embodiments, controlling the pressure within the pilot chamber (e.g., based on valve positioning, based on sensor feedback) to enable the regulator to adjust the pressure in which gas flow is directed toward a consumable may facilitate an case of implementation of the conduit assembly. As an example, it may be easier to implement a regulator rather than another component (e.g., a valve and a corresponding actuator and control circuitry) on a torch to adjust the pressure of gas flow discharged toward the consumable of the torch. For instance, the regulator may occupy a smaller physical footprint and/or utilize fewer or already existing components (e.g., an inlet line, an outlet line) to be installed onboard the torch, especially compared to a valve (e.g., a solenoid valve) configured to move between spaces and/or using supplemental components (e.g., an actuator) to be installed onto the torch. As another example, additional components (e.g., a sensor, a valve, an inlet line to the valve, control circuitry) used to control the onboard regulator, such as the pressure in the pilot chamber of the regulator, may be positioned away or separate from the torch. Thus, such components may not occupy space on the torch. Accordingly, the torch system may be implemented without having to accommodate the positioning of a multitude of components of the conduit assembly onto the torch. As such, using the conduit assembly to adjust gas pressure via a regulator and to adjust the pressure in a pilot chamber of the regulator may be more readily implemented to operate the torch desirably. For example, existing torches may be retrofitted and/or operated with any of the discussed conduit assemblies.

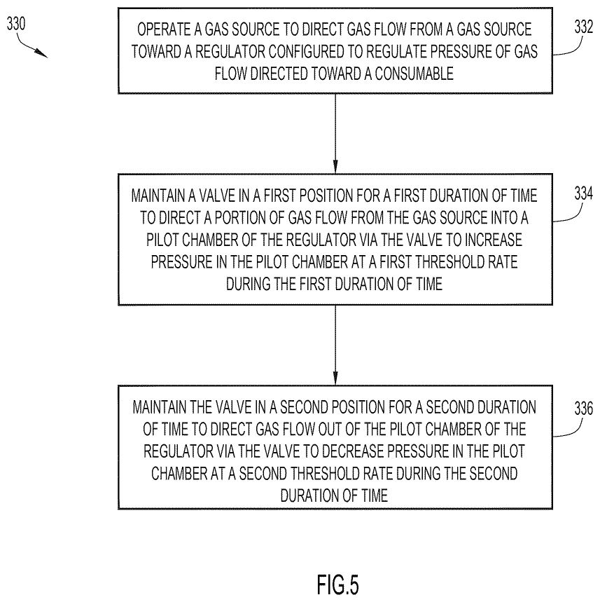

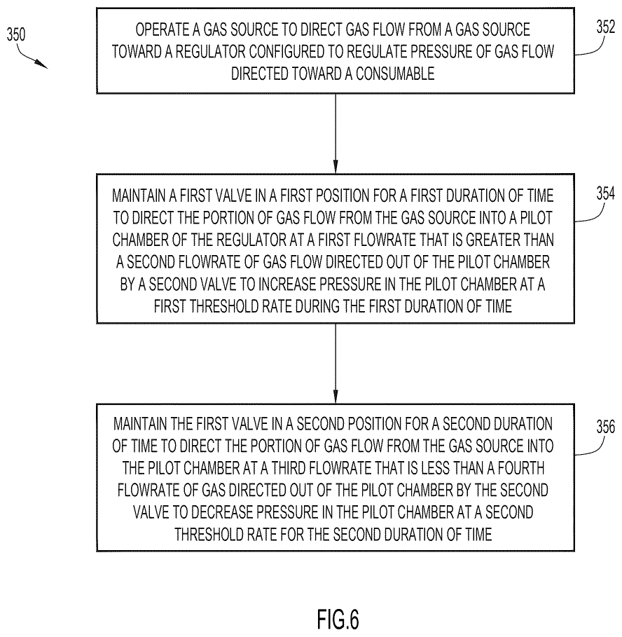

Each of FIGS. 5 and 6 discussed below illustrates a respective method for operating a torch system (e.g., any of the torch systems 150, 200, 250). In some embodiments, the operations of each method are performed by a single entity (e.g., control circuitry). In additional or alternative embodiments, the operations of each method are performed by separate entities. It should be noted that the operations of the method may be performed differently than depicted. For example, an additional operation may be performed, and/or any of the depicted operations may be performed differently, performed in a different order, and/or not performed. Moreover, the operations of the respective methods may be performed in any manner relative to one another, such as sequentially (e.g., in response to one another) and/or concurrently.

FIG. 5 is a flowchart of a method 330 for directing gas flow through a torch system, such as toward a consumable. The method 330 initiates at block 332 by operating a gas source to direct gas flow (e.g., plasma gas flow) from the gas source toward a regulator of a torch system. In some embodiments, gas flow from the gas source is activated by adjusting a valve (e.g., a solenoid valve) to enable gas flow from the gas source into a conduit assembly of the torch system. The regulator is configured to regulate pressure of gas flow directed toward the consumable for generating the arc. For example, the regulator may include a pilot chamber, and the regulator may pressurize the gas flow to a threshold pressure based on a pressure within the pilot chamber and discharge the pressurized gas flow toward the consumable. A pilot circuit of the conduit assembly adjusts the pressure within the pilot chamber by controlling gas flow into and/or out of the pilot chamber.

At block 334, upon initiating the gas flow, a valve of the torch system is transitioned to and maintained in a first position for a first duration of time to divert a portion of the gas flow from the gas source into the pilot chamber of the regulator instead of toward the consumable. Consequently, the amount of gas within the pilot chamber increases to increase the pressure in the pilot chamber. The first position of the valve is configured to direct gas flow into the pilot chamber at a first flowrate, thereby increasing the pressure in the pilot chamber at a corresponding first threshold rate (e.g., a first ramp rate). Thus, during the first duration of time, the valve increases the pressure in the pilot chamber at the first threshold rate to ramp up the threshold pressure of gas flow discharged from the regulator toward the consumable.

At block 336, after the first duration of time has elapsed (e.g., when operation of the torch system is to be suspended or shutdown), the valve is transitioned to and maintained in a second position for a second duration of time to direct gas flow out of the pilot chamber of the regulator to an external environment. As such, the amount of gas within the pilot chamber decreases to reduce the pressure within the pilot chamber. The second position of the valve is configured to direct gas flow out of the pilot chamber at a second flowrate, thereby reducing the pressure in the pilot chamber at a corresponding second threshold rate (e.g., a second ramp rate). As such, during the second duration of time, the valve reduces the pressure in the pilot chamber at the second threshold rate to ramp down the threshold pressure discharged from the regulator toward the consumable. In certain embodiments, the first flowrate at which the first position of the valve directs gas flow into the pilot chamber is substantially equal to the second flowrate at which the second position of the valve directs gas flow out of the pilot chamber. Therefore, the threshold pressure or gas flow discharged toward the consumable ramps up and ramps down at substantially the same rate.

In some embodiments, the valve is a two position valve (e.g., a solenoid valve, a three port two position valve) in which the valve blocks gas flow out of the pilot chamber in the first position and blocks gas flow into the pilot chamber in the second position. For this reason, the valve facilitates buildup of gas within the pilot chamber to increase the pressure in the pilot chamber in the first position, and the valve facilitates discharge of gas from the pilot chamber to reduce the pressure in the pilot chamber in the second position. However, in additional or alternative embodiments, the valve may include any other suitable valve configured to increase pressure in the pilot chamber in the first position and to reduce pressure in the pilot chamber in the second position.

Furthermore, in certain embodiments, the valve may be transitioned to a third position, different from the first position and the second position. As an example, in the third position, the valve may maintain the pressure within the pilot chamber, thereby maintaining the threshold pressure that gas flow is discharged toward the consumable. As another example, the third position may be between the first position and the second position and may direct gas flow into the pilot chamber or direct gas flow out of the pilot chamber at different flowrates. That is, the third position is an intermediate position that helps granularly control the flowrate of gas into and/or out of the pilot chamber. As such, the valve may be transitioned to multiple different positions to adjust the pressure in the pilot chamber and control ramping of the threshold pressure of gas flow discharged from the regulator toward the consumable more acutely.

FIG. 6 is a flowchart of another method 350 for directing gas flow through a torch system, such as toward a consumable. The method 350 initiates at block 352 by also operating a gas source to direct gas flow from a gas source toward a regulator of a torch system. A pilot circuit is used to control gas flow into and/or out of a pilot chamber of the regulator to control the pressure within the pilot chamber, thereby controlling the threshold pressure of gas flow discharged from the regulator toward the consumable for generating an arc. For example, the pilot circuit may include a first valve configured to direct a portion of gas flow from the gas source into the pilot chamber, as well as a second valve configured to direct gas flow out of the pilot chamber. In some embodiments, the second valve remains open, and gas flow is therefore constantly being directed out of the pilot chamber to an external environment to avoid pressure buildup within the pilot chamber.

At block 354, upon initiating the gas flow, the first valve of the torch system is transitioned to and maintained in a first position for a first duration of time to direct the portion of gas flow from the gas source into the pilot chamber of the regulator at a first flowrate that is greater than a second flowrate of gas flow directed out of the pilot chamber by the second valve. Because gas is directed into the pilot chamber at a higher rate than that in which gas is directed out of the pilot chamber, gas builds up in the pilot chamber to increase the pressure in the pilot chamber. Specifically, gas builds up in the pilot chamber at a rate that is approximately a difference between the first flowrate and the second flowrate, and pressure correspondingly increases at a first threshold rate (e.g., a first ramp rate) to ramp up the threshold pressure of gas flow discharged from the regulator toward the consumable.

At block 356, after the duration of time has elapsed (e.g., when operation of the torch system is to be suspended or shutdown), the valve is transitioned to and maintained in a second position for a second duration of time to direct the portion of gas flow from the gas source into the pilot chamber at a third flowrate that is less than a fourth flowrate of gas flow directed out of the pilot chamber by the second valve. Because gas is directed out of the pilot chamber at a higher rate than that in which gas is directed into the pilot chamber, the amount of gas in the pilot chamber decreases to reduce the pressure in the pilot chamber. In particular, the amount of gas in the pilot chamber decreases at a rate that is approximately a difference between the third flowrate and the fourth flowrate, and pressure correspondingly decreases at a second threshold rate (e.g., a second ramp rate) to ramp down the threshold pressure of gas flow discharged from the regulator toward the consumable.

In certain embodiments, the second flowrate in which gas flow is directed out of the pilot chamber by the second valve is substantially equal to the fourth flowrate in which gas flow is directed out of the pilot chamber by the second valve. For example, the second valve may be fixed and may not adjust the flowrate of gas being directed out of the pilot chamber. Rather, the first valve is adjusted between the first position and the second position to effectuate a difference between the flowrate of gas being directed into the pilot chamber and the flowrate of gas being directed out of the pilot chamber. However, in some embodiments, the second flowrate and the fourth flowrate are different from one another. For instance, the fourth flowrate may be greater than the second flowrate to facilitate reducing the amount of gas in the pilot chamber. It should also be noted that the first valve and the second valve may be transitioned to and/or maintained at any other suitable position to adjust the flowrate of gas directed into the pilot chamber relative to the flowrate of gas directed out of the pilot chamber. By way of example, the first valve and the second valve may be adjusted to direct gas flow into the pilot chamber at substantially the same flowrate in which gas flow is directed out of the pilot chamber, thereby substantially maintaining an amount of gas in the pilot chamber to maintain the pressure in the pilot chamber and the threshold pressure of gas discharged from the regulator toward the consumable. The flowrate of gas flow directed into the pilot chamber relative to the flowrate of gas flow directed out of the pilot chamber may also be adjusted to any other suitable amount to granularly adjust the flowrate of gas into or out of the pilot chamber, thereby acutely controlling the pressure in the pilot chamber and the ramping of the threshold pressure of gas flow discharged from the regulator toward the consumable.

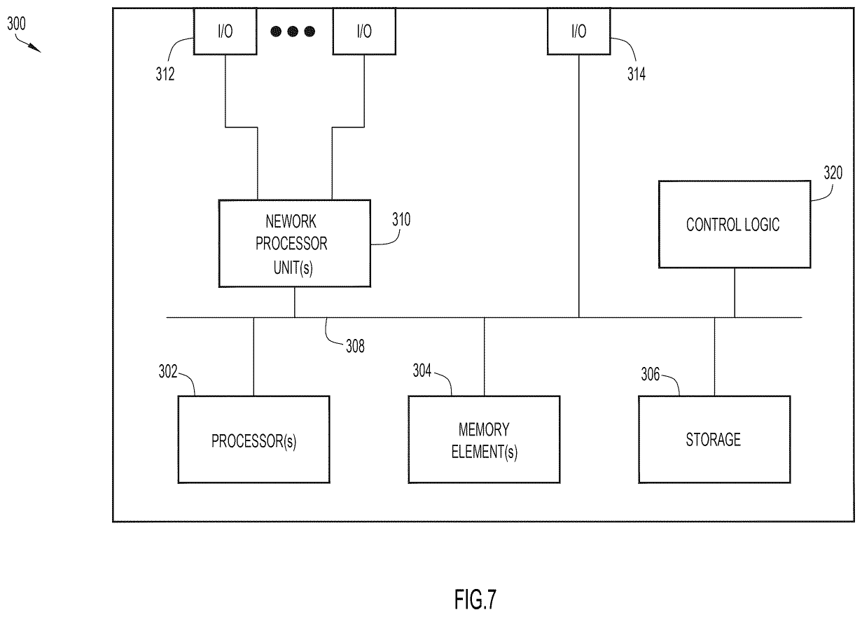

FIG. 7 illustrates a hardware block diagram of a computing device 300 that may execute the techniques presented herein. This computing device 300 may be included in or formed from portions of any combination of parts included in the controller 16, the automated plasma arc torch 18, the power supply 14, and/or the positioning system 12 of an automated cutting system 10, as well as a control system of any of the torch systems 150, 200, 250. Thus, any of the controller 16, the automated plasma arc torch 18, the power supply 14, the positioning system 12, and/or the control system may execute the techniques presented herein, alone or in combination with one or more other systems/components.

As depicted, the computing device 300 includes a bus 308, which provides communications between processor(s) 302, one or more memory elements 304, persistent storage or memory 306, one or more network processor units 310 (i.e., a communications unit), and input/output (I/O) interface(s) 314. The bus 308 can be implemented with any architecture designed for passing data and/or control information between processors (such as microprocessors, communications and network processors, etc.), system memory, peripheral devices, and any other hardware components within a system. For example, the bus 308 can be implemented with one or more buses.

The memory 306 and/or memory element 304 may include random access memory (RAM) or other dynamic storage devices (i.e., dynamic RAM (DRAM), static RAM (SRAM), and synchronous DRAM (SD RAM)), for storing information and instructions to be executed by the processor 302. The memory 306 and/or memory element 304 may also include a read only memory (ROM) or other static storage device (i.e., programmable ROM (PROM), erasable PROM (EPROM), and electrically erasable PROM (EEPROM)) for storing static information and instructions for the processor 302. Additionally, although “control logic” 320 is illustrated separately from the memory 306 and/or memory element 304, the control logic 320 may be stored as non-transitory computer-readable instructions in the memory 306 and/or memory element 304, for execution by the processor 302 so that the processor 302 can execute the techniques presented herein.

Although FIG. 7 shows the processor 302 as a single box, it should be understood that the processor 302 may represent a plurality of processing cores, each of which can perform separate processing. The processor 302 may also include special purpose logic devices (i.e., application specific integrated circuits (ASICs)) or configurable logic devices (i.e., simple programmable logic devices (SPLDs), complex programmable logic devices (CPLDs), and field programmable gate arrays (FPGAs)), that, in addition to microprocessors and digital signal processors may individually, or collectively, are types of processing circuitry.

The processor 302 performs a portion or all of the processing steps required to execute the techniques presented herein, e.g., in response to instructions received at the network processor unit(s) 310 and/or instructions contained in the memory 304 and/or memory 306. Such instructions may be read into the memory 304 and/or memory 306 from another computer-readable medium. One or more processors in a multi-processing arrangement may also be employed to execute the sequences of instructions contained in the memory 304 and/or memory 306. In alternative embodiments, hard-wired circuitry may be used in place of or in combination with software instructions. Thus, embodiments are not limited to any specific combination of hardware circuitry and software. Put another way, the computing device 300 includes at least one computer-readable medium or memory for holding instructions programmed according to the embodiments presented, for containing data structures, tables, records, or other data described that might be required to execute the techniques presented herein.

Still referring to FIG. 7, the network processor unit(s) 310 provides a two-way data communication coupling to a network, such as a local area network (LAN) or the Internet. The two-way data communication coupling provided by the network processor unit(s) 310 can be wired (e.g., via I/O interface(s) 312) or wireless. Meanwhile, I/O interface(s) 314 may allow for input and output of data with other devices that may be connected to the computer device 300. For example, the I/O interface 314 may provide a connection to external devices such as a keyboard, keypad, a touch screen, and/or some other suitable input device. External devices can also include portable computer-readable storage media such as database systems, thumb drives, portable optical or magnetic disks, and memory cards.

While the apparatuses and methods presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. For example, the vibration analysis apparatuses presented herein may be modified to contain any number of signal output generating devices, vibration capturing devices, vibration analysis computing devices, etc., and the vibration analysis computing devices may connect to any number of input and output devices, along with any number of networks and/or servers. Additionally, the methods presented herein may be suitable for any type of welding and/or cutting consumable assemblies, including consumable assemblies utilized for automated (e.g., mechanized) and/or manual (e.g., handheld) operations.

In addition, various features from one of the embodiments may be incorporated into another of the embodiments. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “rear,” “front,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the components of the apparatuses described herein, the consumable assemblies described herein, or portions thereof may be fabricated from any suitable material or combination of materials, such as plastic or metals (e.g., copper, bronze, hafnium, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A plasma torch system configured to direct a gas flow from a gas source toward a consumable of a plasma torch, the plasma torch system comprising:
a regulator configured to receive a first portion of the gas flow from the gas source and direct the first portion of the gas flow toward the consumable of the plasma torch, wherein the regulator comprises a pilot chamber, and the regulator is configured to regulate a pressure of the first portion of the gas flow directed toward the consumable of the plasma torch based on a pressure in the pilot chamber; and
a valve fluidly coupled to the pilot chamber of the regulator and configured to direct a second portion of the gas flow from the gas source toward the pilot chamber, wherein the valve is configured to transition between a first position and a second position, the valve, in the first position, is configured to increase the pressure in the pilot chamber at a first ramp rate, and the valve, in the second position, is configured to decrease the pressure in the pilot chamber at a second ramp rate.

2. The plasma torch system of claim 1, comprising an additional valve fluidly coupled to the pilot chamber of the regulator and configured to direct the gas flow out of the pilot chamber.

3. The plasma torch system of claim 2, wherein:
the additional valve is configured to direct at least some of the second portion of the gas flow out of the pilot chamber at a first flowrate; and
the valve, in the first position, is configured to direct the second portion of the gas flow at a second flowrate greater than the first flowrate to increase the pressure in the pilot chamber at the first ramp rate while the additional valve is in the third position.

4. The plasma torch system of claim 3, wherein the valve, in the second position, is configured to direct the second portion of the gas flow at a third flowrate less than the first flowrate to decrease the pressure in the pilot chamber at the second ramp rate while the additional valve is in the third position.

5. The plasma torch system of claim 3, wherein the additional valve is configured to transition between a third position, which directs at least some of the second portion of the gas flow out of the pilot chamber at the first flowrate, and a fourth position, which directs at least some of the second portion of the gas flow out of the pilot chamber at a third flowrate.

6. The plasma torch system of claim 5, wherein the valve, in the second position, is configured to direct the second portion of the gas flow at a fourth flowrate less than the third flowrate to decrease the pressure in the pilot chamber at the second ramp rate while the additional valve is in the fourth position.

7. The plasma torch system of claim 1, wherein the second position of the valve is a closed position to block the second portion of the gas flow from the gas source toward the pilot chamber.

8. The plasma torch system of claim 1, further comprising:
a first line configured to direct the second portion of the gas flow from the gas source toward the pilot chamber of the regulator, wherein the first position of the valve fluidly couples the first line to the pilot chamber to direct the second portion of the gas flow from the gas source to the pilot chamber to increase the pressure in the pilot chamber at the first ramp rate; and
a second line configured to direct the gas flow away from the pilot chamber of the regulator, wherein the second position of the valve fluidly couples the second line to the pilot chamber to direct the gas flow out of the pilot chamber to decrease the pressure in the pilot chamber at the second ramp rate.

9. The plasma torch system of claim 1, wherein the valve comprises a solenoid valve.

10. The plasma torch system of claim 1, further comprising a control system configured to transition the valve between the first position and the second position without usage of a sensor configured to determine a pressure of the gas flow.

11. A method for directing a gas flow from a gas source toward a consumable of a plasma torch, the method comprising:
directing a first portion of the gas flow from the gas source to a regulator, wherein the regulator comprises a pilot chamber;
regulating, via the regulator, a pressure of the first portion of the gas flow directed toward the consumable based on a pressure in the pilot chamber of the regulator;
directing a second portion of the gas flow from the gas source to a valve fluidly coupled to the pilot chamber of the regulator, wherein the valve is configured to transition between a first position and a second position, the valve is configured to increase the pressure in the pilot chamber in the first position, and the valve is configured to decrease the pressure in the pilot chamber in the second position; and
adjusting the pressure in the pilot chamber of the regulator via the valve.

12. The method of claim 11, comprising directing, via an additional valve, at least some of the second portion of the gas flow out of the pilot chamber at a first flowrate, and wherein adjusting the pressure in the pilot chamber of the regulator via the valve comprises directing, via the valve in the first position, the second portion of the gas flow at a second flowrate, greater than the first flowrate, to increase the pressure in the pilot chamber at a first ramp rate.

13. The method of claim 12, wherein adjusting the pressure in the pilot chamber of the regulator via the valve comprises directing, via the valve in the second position, the second portion of the gas flow at a third flowrate, less than the first flowrate of the second portion of the gas flow directed out of the pilot chamber via the additional valve, to decrease the pressure in the pilot chamber at a second ramp rate.

14. The method of claim 11, wherein adjusting the pressure in the pilot chamber of the regulator via the valve comprises directing, via the valve in the first position, the second portion of the gas flow from the gas source to the pilot chamber through a line to increase the pressure in the pilot chamber.

15. The method of claim 14, comprising directing, via the valve in the second position, gas flow out of the pilot chamber of the regulator through an additional line to decrease the pressure in the pilot chamber.

16. A plasma torch system configured to direct gas flow from a gas source toward a consumable of a plasma torch, comprising:
a regulator configured to receive a first portion of gas flow from the gas source and direct the first portion of gas flow toward the consumable of the plasma torch, wherein the regulator comprises a pilot chamber, and the regulator is configured to regulate a pressure of the first portion of gas flow directed toward the consumable of the plasma torch based on a pressure in the pilot chamber; and
a pilot circuit comprising a valve and a line configured to direct a second portion of gas flow from the gas source toward the pilot chamber of the regulator via the valve to control the pressure of the first portion of gas flow with the second portion of gas flow.

17. The plasma torch system of claim 16, wherein the pilot circuit comprises:
an additional line configured to direct gas flow away from the pilot chamber via the valve, wherein the valve is configured to transition between a first position and a second position, the first position of the valve fluidly couples the line to the pilot chamber to increase the pressure in the pilot chamber, and the second position of the valve fluidly couples the additional line to the pilot chamber to decrease the pressure in the pilot chamber.

18. The plasma torch system of claim 17, wherein the first position of the valve increases the pressure in the pilot chamber at a first ramp rate and the second position of the valve decreases the pressure in the pilot chamber at a second ramp rate.

19. The plasma torch system of claim 16, wherein the pilot circuit comprises:
an additional line configured to direct gas flow out of the pilot chamber at a first flowrate, wherein the valve is configured to direct the second portion of gas flow from the gas source into the pilot chamber at a second flowrate, different from the first flowrate, to adjust the pressure in the pilot chamber.

20. The plasma torch system of claim 19, wherein the pilot circuit comprises:
an additional valve configured to adjust the first flowrate of gas flow directed out of the pilot chamber.
